(19) United States
(12) Patent Application Publication
(10) Pub. No.: US 2016/0024955 A1
(43) Pub. Date: Jan. 28, 2016

(54) Maxmet Composites for Turbine Engine Component Tips

(71) Applicant: UNITED TECHNOLOGIES CORPORATION, Hartford, CT (US)

(72) Inventors: Shahram Amini, Glastonbury, CT (US); Christopher W Strock, Kennebunk, ME (US); Sergei F Burlatsky, West Hartford, CT (US); Dmitri Novikov, Avon, CT (US); David Ulrich Fuller, Marlborough, CT (US)

(21) Appl. No.: 14/775,927

(22) PCT Filed: Dec. 16, 2013
(86) PCT No.: PCT/US2013/075292

§ 371 Date: Sep. 14, 2015

Related U.S. Application Data
(60) Provisional application No. 61/788,056, filed on Mar. 15, 2013.

(51) Int. Cl. F01D 11/12; F01D 9/04; B23K 1/00; B23K 1/19; C23C 24/04; B23K 20/22; B23K 26/34; B23K 26/00; C23C 4/12; F01D 5/28; B23K 20/02

(52) U.S. Cl. CPC F01D 11/122; F01D 5/288; F01D 9/041; B23K 1/0006; B23K 1/19; B23K 20/02; B23K 20/22; B23K 26/34; B23K 26/0006; C23C 4/127; C23C 24/04; F05D 2220/30; F05D 2230/312; F05D 2230/90; F05D 2230/237; F05D 2230/236; F05D 2230/60; F05D 2240/307; F05D 2240/125; F05D 2300/6032; B23K 2203/16

(57) ABSTRACT

A turbine engine system includes a turbine engine component having an airfoil portion and a tip, which turbine engine component having a MAXMET composite bonded to the tip. The MAXMET composite has MAX phases in a metal matrix.

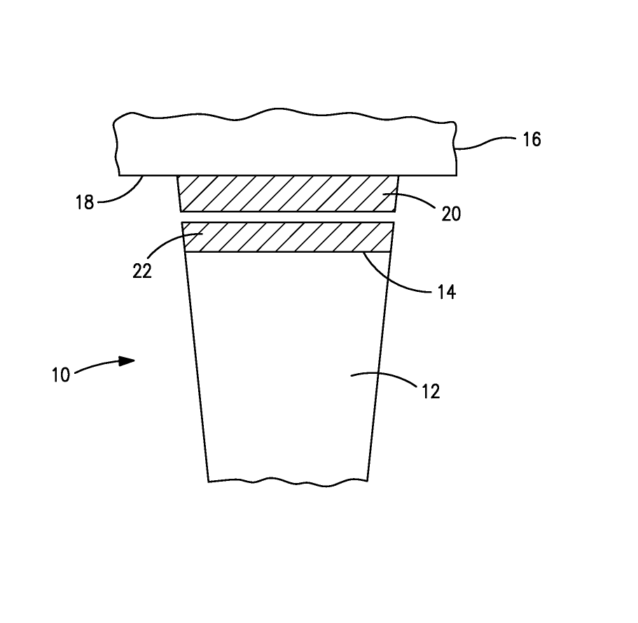

### BACKGROUND

The present disclosure is directed to the use of MAXMET composites on the tip of an airfoil portion of a turbine engine component for rub and abradability against an abrasive rotor coating.

Compressor technology uses abradable coatings for fuel burn reduction and increases in temperature capability. In some compressor systems, a coating is applied to the tip of an airfoil portion of a compressor blade or vane to rub against an abrasive coating applied to another component. Abradable systems are not currently capable of achieving the full desirable tightest rubs and they suffer from multiple premature failure types due to high rub forces, rough coating surfaces, local heat generation, high coating temperature, blade material transfer, coating spallation, and durability issues at high temperatures. There are several requirements to mitigate issues associated with abradable coatings, such as improved abradable damage tolerance and toughness, improved thermal cycling and durability, tailored thermal expansion, reduced frictional forces and low coefficient of friction, self-lubrication and low energy of cut, high abradable thermal conductivity and higher erosion resistance and desired wear ratio.

### SUMMARY

In accordance with the present disclosure, there is provided a turbine engine system which broadly comprises a turbine engine component having an airfoil portion and a tip; and the turbine engine component having a MAXMET composite bonded to the tip.

In another and alternative embodiment, the MAXMET composite is a composite having MAX phases and a metal matrix.

In another and alternative embodiment, the metal matrix is at least one of a low, medium, and high melting point metal or metal alloy.

In another and alternative embodiment, the MAX phases are defined by the formula Mₙ₊₁AXₙ where M is selected from the early transition metals, A is selected from A-group elements, X is selected from the group consisting of carbon and nitrogen, and n 32 1 to 3.

In another and alternative embodiment, the turbine engine system further comprises an abradable coating which is engaged by the tip of the turbine engine component with the MAXMET composite.

In another and alternative embodiment, the turbine engine component is a vane.

In another and alternative embodiment, the turbine engine component is a blade.

Further in accordance with the present disclosure, there is provided a turbine engine component which broadly comprises an airfoil portion having a tip; and a MAXMET composite bonded to the tip.

In another and alternative embodiment, the MAXMET composite is a composite having MAX phases and a metal matrix.

In another and alternative embodiment, the metal matrix is at least one of a low, medium, and high melting point metal or metal alloy.

In another and alternative embodiment, the MAX phases are defined by the formula Mₙ₊₁AXₙ where M is selected from the early transition metals, A is selected from A-group elements, X is selected from the group consisting of carbon and nitrogen, and n=1 to 3.

In another and alternative embodiment, the turbine engine component is a vane.

In another and alternative embodiment, the turbine engine component is a blade.

Further in accordance with the present disclosure, there is provided a process for manufacturing a turbine engine component which broadly comprises the steps of: providing a MAXMET composite material; providing a partially machined forging of a material to be used to form said turbine engine component; and joining the MAXMET composite ring to the partially machined forging.

In another and alternative embodiment, the joining step comprises diffusion bonding of the MAXMET composite material to the partially machined forging.

In another and alternative embodiment, the joining step comprises transient liquid phase brazing of the MAXMET composite material to the partially machined forging.

In another and alternative embodiment, the joining step comprises using one of plasma spray, high velocity oxy-fuel coating spraying, cold spray and laser powder cladding to join the MAXMET composite material to the partially machined forging.

In another and alternative embodiment, the process further comprises machining the forging to form an airfoil portion with the MAXMET composite material being joined to a tip of the airfoil portion.

In another and alternative embodiment, the MAXMET composite providing step comprises providing a composite having MAX phases and a metal matrix.

In another and alternative embodiment, the metal matrix is a metal matrix and the MAX phases are defined by the formula Mₙ₊₁AXₙ where M is selected from the early transition metals, A is selected from A-group elements, X is selected from the group consisting of C and N, and n=1 to 3.

Other details of the MAXMET composites for turbine engine component tips are set forth in the following detailed description and the accompanying drawing wherein like reference numerals depict like elements.

### BRIEF DESCRIPTION OF THE DRAWINGS

The FIGURE is a schematic representation of a MAXMET composite coating applied to a tip of a turbine engine component.

### DETAILED DESCRIPTION

Referring now to the FIGURE, there is illustrated a turbine engine component 10, such as a compressor blade or vane. The turbine engine component 10 has an airfoil portion 12 with a tip 14. Surrounding the turbine engine component 10 is a casing 16. The interior surface 18 of the casing 16 has an abradable coating 20 applied to it. The abradable coating 20 may be a metal matrix.

The turbine engine component 10 may be formed from a titanium-based alloy or a nickel-based alloy. On the tip 14 of the airfoil portion 12, a composite material 22 is applied for rub and abradability against the abradable coating 20.

The composite material 22 may be a MAXMET composite which is a MAX-based metal matrix composite. The composite contain MAX phases which are defined by the formula Mₙ₊₁AXₙ where n is a number from 1 to 3. M is an early transition metal element, A is an A group element, and X is carbon (C) or nitrogen (N). Early transition metals are any element in the d-block of the periodic table, which includes groups 3 to 12 on the periodic table. A-group elements are mostly group IIA or IVA. The metal matrix is at least one of a low, medium, and high melting point metal or metal alloy. Low melting point metals or metal alloys are those approximately in the range of from 100 degrees Centigrade to 300 degrees Centigrade. Medium melting point metals or metal alloys are those approximately in the range of 300 degrees Centigrade to 1000 degrees Centigrade. High melting point metals or metal alloys are those in the range of 1000 degrees Centigrade and greater. MAXMET materials are characterized by excellent mechanical properties and improved toughness, high damage tolerance, high thermal stability and improved erosion resistance.

The composite 22 may be applied to the tip 14 of the airfoil portion 12 by diffusion bonding or transient liquid phase brazing a hot pressed MAXMET composite ring onto a partially machined forging of the material forming the turbine engine component 10 prior to machining of the airfoil portion 12.

While diffusion bonding and transient liquid phase have been described as bonding techniques for joining the MAXMET composite 22 to the tip 14 of the airfoil portion, other bonding techniques could be used. For example, one could use plasma spray, high-velocity oxy-fuel coating spraying, cold spray or laser powder cladding to apply the MAXMET composite 22 to the tip 14.

MAXMET composites have the potential to reduce frictional forces with low coefficient of friction. The MAXMET composites offer superb machinability with low energy of cut and self-lubricating capability. High thermal conductivity reduces local heat generation and creates cooler rub contact to prevent metal transfer to the abrasive coating. Improved oxidation resistance and improved thermal stability will be beneficial for higher temperature abradable coatings. Strong bonding of MAX phases to metallic matrices increases toughness and provides processing capability with bulk and deposition techniques and ability to process with porosity. Tailored thermal expansion coefficient will also contribute to durability of abradable coatings. MAX phases will be durable in the oxidizing environment of a gas turbine's high pressure compressor up to 900 degrees Centigrade and more which exceeds the requirements for use in today's advanced gas turbines.

There has been provided a MAXMET composite for turbine engine component tips. While the MAXMET composite has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A turbine engine system comprising:
a turbine engine component having an airfoil portion and a tip;
said turbine engine component having a MAXMET composite bonded to said tip.

2. The turbine engine system according to claim 1, wherein said MAXMET composite is a composite having MAX phases and a metal matrix.

3. The turbine engine system according to claim 2, wherein said metal matrix is at least one of a low, medium, and high melting point metal or metal alloy.

4. The turbine engine system according to claim 2, wherein said MAX phases are defined by the formula Mₙ₊₁AXₙ where M is an early transition metal element, A is an A-group element, X is C or N, and n=1 to 3.

5. The turbine engine system according to claim 1, further comprising an abradable coating which is engaged by the tip of said turbine engine component with said MAXMET composite.

6. The turbine engine system according to claim 1, wherein said turbine engine component is a vane.

7. The turbine engine system according to claim 1, wherein said turbine engine component is a blade.

8. A turbine engine component comprising:
an airfoil portion having a tip; and
a MAXMET composite bonded to said tip.

9. The turbine engine component according to claim 8, wherein said MAXMET composite is a composite having MAX phases and a metal matrix.

10. The turbine engine component according to claim 9, wherein said metal matrix is at least one of a low, medium, and high melting point metal or metal alloy.

11. The turbine engine component according to claim 9, wherein said MAX phases are defined by the formula Mₙ₊₁AXₙ where M is an early transition metal element, A is an A group element, X is carbon or nitrogen, and n=1 to 3.

12. The turbine engine system according to claim 8, wherein said turbine engine component is a vane.

13. The turbine engine system according to claim 8, wherein said turbine engine component is a blade.

14. A process for manufacturing a turbine engine component, said process comprising the steps of:
providing a MAXMET composite material;
providing a partially machined forging of a material to be used to form said turbine engine component; and
joining said MAXMET composite ring to said partially machined forging.

15. The process of claim 14, wherein said joining step comprises diffusion bonding of said MAXMET composite material to said partially machined forging.

16. The process of claim 14, wherein said joining step comprises transient liquid phase brazing of said MAXMET composite material to said partially machined forging.

17. The process of claim 14, wherein said joining step comprises using one of plasma spray, high velocity oxy-fuel coating spraying, cold spray and laser powder cladding to join said MAXMET composite material to said partially machined forging.

18. The process of claim 14, further comprising machining said forging to form an airfoil portion with said MAXMET composite material being joined to a tip of said airfoil portion.

19. The process of claim 14, wherein said MAXMET composite providing step comprises providing a composite having MAX phases and a metal matrix.

20. The process of claim 19, wherein said metal matrix is at least one of a low, medium, and high melting point metal or metal alloy and said MAX phases are defined by the formula Mₙ₊₁AXₙ where M is an early transition metal element, A is an A group element, X is carbon or nitrogen, and n=1 to 3.
